(19) United States
(12) Patent Application Publication
(10) Pub. No.: US 2019/0370920 A1
(43) Pub. Date: Dec. 5, 2019

(54) ECONOMIC VALUE MANAGEMENT APPARATUS AND ECONOMIC VALUE MANAGEMENT METHOD

(71) Applicant: TOYOTA JIDOSHA KABUSHIKI KAISHA, Toyota-shi (JP)

(72) Inventors: Shuntaro SHINOHARA, Susono-shi (JP); Yoshiyuki KAGEURA, Sunto-gun (JP)

(73) Assignee: TOYOTA JIDOSHA KABUSHIKI KAISHA, Toyota-shi (JP)

(21) Appl. No.: 16/419,211

(22) Filed: May 22, 2019

(30) Foreign Application Priority Data
Jun. 5, 2018 (JP) 2018-107918

(51) Int. Cl. G06Q 50/26; G06Q 20/10

(52) U.S. Cl. CPC G06Q 50/26; G06Q 20/10

(57) ABSTRACT

An economic value management apparatus assesses the action relating to the operation of the request receiving vehicle associated with the request receiving terminal when receiving from one terminal among a plurality of terminals becoming a request sending terminal a signal to the effect of paying another terminal among the plurality of terminals becoming a request receiving terminal the economic value as payment for having taken an action requested from the request sending terminal, and when the assessment of the action relating to operation of the request receiving vehicle is less than a predetermined assessment, invalidates the payment of economic value to the request receiving terminal or lowers the amount of payment of economic value compared with the case where the assessment is the predetermined assessment or more.

### CROSS-REFERENCE TO RELATED APPLICATION

This application claims priority based on Japanese Patent Application No. 2018-107918 filed with the Japan Patent Office on Jun. 5, 2018, the entire contents of which are incorporated into the present specification by reference.

### FIELD

The present disclosure relates to an economic value management apparatus and economic value management method.

### BACKGROUND

Japanese Unexamined Patent Publication No. 2005-190233 discloses a road management system which discounts a toll charge or otherwise gives economic value to a vehicle driven on a specific lane among a cruising lane, a passing lane, etc. so as to be able to proactively promote driving in a specific lane.

### SUMMARY

In the above-mentioned patent publication, a vehicle driving in a specific lane was given economic value, but in addition to this, for example, it may also be considered to give economic value to a vehicle or the user of that vehicle taking specific action such as changing a lane to yield the road to a vehicle approaching from behind or yielding a parking space occupied by oneself to a vehicle looking for a parking space etc. However, if doing this, in an attempt to obtain more economic value, persons are liable to appear who engage in actions contrary to traffic rules or morals so as to try to obtain economic value.

The present disclosure was made focusing on such a problem and has as its object to provide an economic value management apparatus and economic value management method able to keep economic value from ending up being given to persons engaging in actions contrary to traffic rules or morals.

To solve the above problem, the economic value management apparatus according to one aspect of the present disclosure comprises a communication part configured to be able to communicate with a plurality of terminals associated with different vehicles, a storage part configured to store economic value held by users of the plurality of terminals or the vehicles associated with the plurality of terminals, a control part configured to exchange economic value among the plurality of terminals. The control part is configured so that when receiving from one terminal among the plurality of terminals becoming a request sending terminal a signal to the effect of paying economic value to another terminal among the plurality of terminals becoming a request receiving terminal as payment for having taken an action requested from the request sending terminal, it assesses the action relating to the operation of the request receiving vehicle associated with the request receiving terminal and when the assessment of the action relating to operation of the request receiving vehicle is less than a predetermined assessment, invalidates the payment of economic value to the request receiving terminal or lowers the amount of economic value paid compared with the case where the assessment is the predetermined assessment or more.

Further, the economic value management method according to another aspect of the present disclosure is an economic value management method for managing economic value which is stored in a server configured to be able to communicate with a plurality of terminals and is held by users of the plurality of terminals or vehicles associated with the plurality of terminals, which method assesses an action relating to the operation of a request receiving vehicle associated with a request receiving terminal when one terminal among the plurality of terminals becoming a request sending terminal pays economic value to another terminal among the plurality of terminals becoming a request receiving terminal and when the assessment of the action relating to operation of the request receiving vehicle is less than a predetermined assessment, invalidates the payment of economic value to the request receiving terminal or lowers the amount of economic value paid compared with the case where the assessment is the predetermined assessment or more.

According to these aspects of the present disclosure, it is possible to keep economic value from ending up being given to a person whose action relating to operation is assessed low, so it is possible to keep economic value from ending up being given to a person taking problematic action contrary to traffic rules or morals.

### BRIEF DESCRIPTION OF DRAWINGS

FIG. 1 is a schematic view of the configuration of an economic value management system according to a first embodiment of the present disclosure.

FIG. 2 is a schematic view of the configuration of a server.

FIG. 3 is a schematic view of the configuration of a terminal.

FIG. 4 is a view showing an example of a state in the economic value management system where processing for managing economic value and processing for updating problematic action information are performed.

FIG. 5 is a view showing one example of a sequence of operations in processing for updating problematic action points according the first embodiment of the present disclosure.

FIG. 6 is a view showing one example of a sequence of operations in processing for managing economic value according to the first embodiment of the present disclosure.

FIG. 7 is a flow chart for explaining processing relating to the server in processing for updating problematic action points according the first embodiment of the present disclosure.

FIG. 8 is a flow chart for explaining processing relating to the server in processing for managing economic value according the first embodiment of the present disclosure.

FIG. 9 is view showing one example of the sequence of operations in processing for managing economic value according to a second embodiment of the present disclosure.

FIG. 10 is a flow chart for explaining processing relating to the server in processing for managing economic value according the second embodiment of the present disclosure.

### DESCRIPTION OF EMBODIMENTS

Below, referring to the drawings, embodiments of the present disclosure will be explained in detail. Note that, in the following explanation, similar component elements will be assigned the same reference numerals.

### First Embodiment

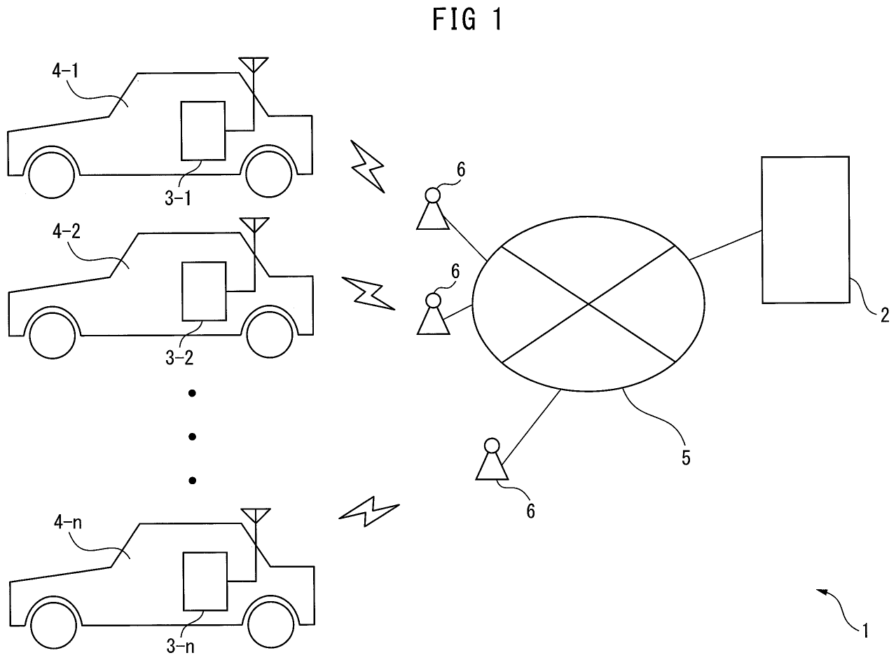

FIG. 1 is a schematic view of the configuration of an economic value management system 1 according to a first embodiment of the present disclosure.

The economic value management system 1 according to the present embodiment comprises a server 2 as one example of an economic value management apparatus and a plurality of terminals 3-1 to 3-n (“n” is an integer of 3 or more). The terminal 3-1 is associated with a vehicle 4-1. Similarly, the terminals 3-2 to 3-n are associated with the vehicles 4-2 to 4-n.

The server 2 is connected with a communication network 5 comprised of optical communication lines etc., through a gateway (not shown), etc. The terminals 3-1 to 3-n access wireless base stations 6 connected with the communication network 5 through a gateway etc. and thereby are connected with the communication network 5 through the wireless base stations 6. That is, the server 2 and the plurality of terminals 3-1 to 3-n can communicate with each other through the communication network 5.

The terminals 3-1 to 3-n are, for example, mobile phones or tablet computers or other mobile terminals having wireless communication functions or are car mounted navigation systems. Note that, the terminals 3-1 to 3-n may all be equipment of the same type as each other or may all be equipment of different types from each other. For example, the terminal 3-1 may be a mobile phone while the terminal 3-2 may be a navigation system mounted in the vehicle 4-2 associated with the terminal 3-2.

The economic value management system 1 according to the present embodiment performs processing for managing economic value which determines whether to pay economic value to the user of another vehicle (or terminal) based on results of assessment of an action relating to the operation by the user of the other vehicle if the user of the other vehicle takes a specific action requested from the user of one vehicle (or terminal) conditional on payment of economic value from the user of the one vehicle.

Further, the economic value management system 1 according to the present embodiment is designed to be able to report a vehicle taking action contrary to traffic rules or morals (below referred to as “problematic action”) as a “problem vehicle” for assessing an action relating to operation of a user of another vehicle receiving a request from a user of one vehicle for taking specific action. Further, the economic value management system 1 performs processing for updating problematic action points which updates the problematic action points (points accumulated in accordance with number of times or content of problematic actions) of the user of a vehicle reported as a problem vehicle each time the vehicle is reported as a problem vehicle.

Due to this, for example, if a user of a certain vehicle (or terminal) deliberately induces a request for obtaining economic value by taking problematic action, it is possible to keep payment of economic value from being made as a reward to such a user for taking specific action. Further, as a result, it is possible to keep a problematic action itself from being performed so as to obtain economic value.

Note that, as an example of specific action requested conditional on payment of economic value, a lane change from the passing lane to a cruising lane when receiving a request for passing, movement from a parking space when receiving a request for movement from the parking space, etc. may be mentioned.

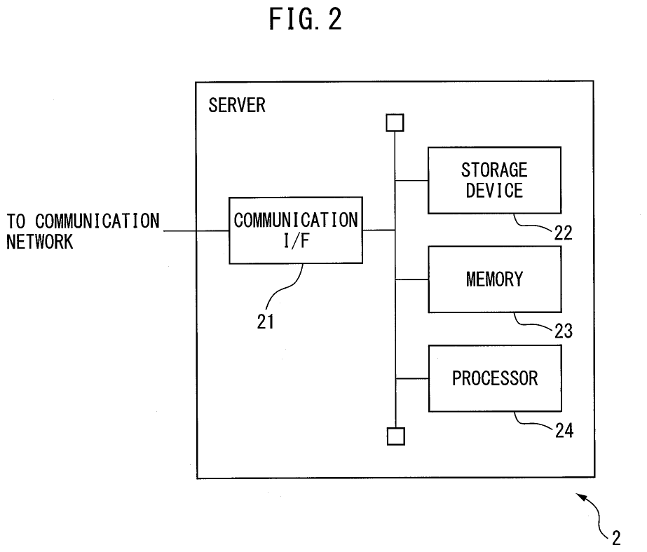

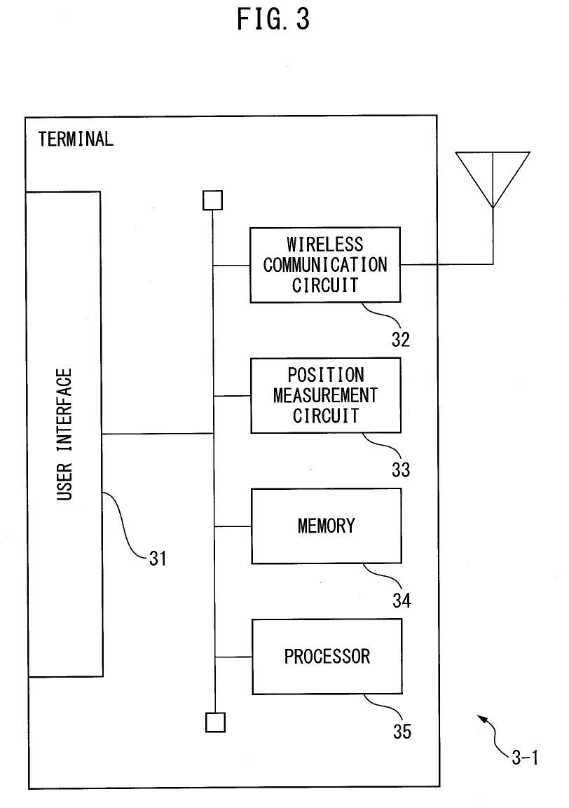

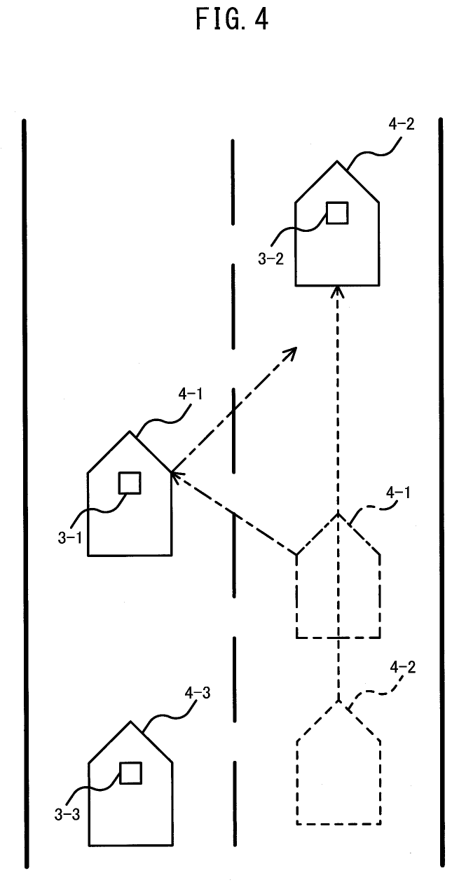

Below, referring to FIG. 2 and FIG. 3, the detailed configurations of the server 2 and the terminals 3-1 to 3-n will be explained, then, referring to FIG. 4 to FIG. 6, details of the processing for managing economic value and the processing for updating problematic action points will be explained.

FIG. 2 is a schematic view of the configuration of the server 2.

As shown in FIG. 2, the server 2 is comprised of a communication interface 21, storage device 22, memory 23, and processor 24. The communication interface 21, storage device 22, and memory 23 are connected with the processor 24 through signal lines. The server 2 may further comprise input devices of a keyboard and mouse and an output device of a display.

The communication interface 21 is one example of a communication part. It is comprised of an interface circuit for connecting the server 2 to a communication network 5 and is configured to be able to communicate with the terminals 3-1 to 3-n through the communication network 5.

The storage device 22 is one example of a storage part and for example comprises a hard disk drive or optical recording medium and an access device of the same.

The storage device 22 stores identification information of the terminals 3-1 to 3-n and identification information and current positions etc. of the vehicles 4-1 to 4-n associated with the terminals 3-1 to 3-n all linked together. The identification information of the terminals 3-1 to 3-n can, for example, be made MAC addresses. The identification information of the vehicles 4-1 to 4-n can, for example, be made license plate numbers of the vehicles 4-1 to 4-n.

Further, the storage device 22 stores names and user numbers of users of the terminals 3-1 to 3-n, point information showing economic value, economic value exchange information, problematic action points, etc. The economic value exchange information is information including the content of a request when a request for passing (request for lane change), request for movement from a parking space, or other request for the users of the terminals 3-1 to 3-n to take specific action accompanied with exchange of economic value is made and the date and time when that request is agreed to and economic value is received (date and time of economic value receipt). Further, the storage device 22 stores map information.

Note that, in the present embodiment, the example is shown where point information expressing economic value is held by the users of the terminals 3-1 to 3-n, but the disclosure is not limited to this. The point information expressing economic value for example may also be held by the vehicles 4-1 to 4-n associated with the terminals 3-1 to 3-n.

The memory 23 is another example of a storage part and for example comprises a nonvolatile semiconductor memory and a volatile semiconductor memory. The memory 23 stores various types of data generated during performance of processing for managing economic value and processing for updating problematic action points.

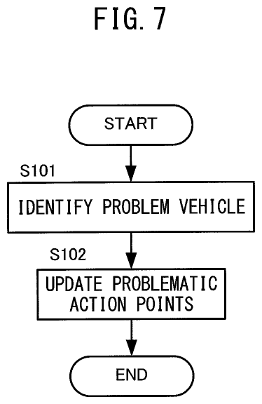

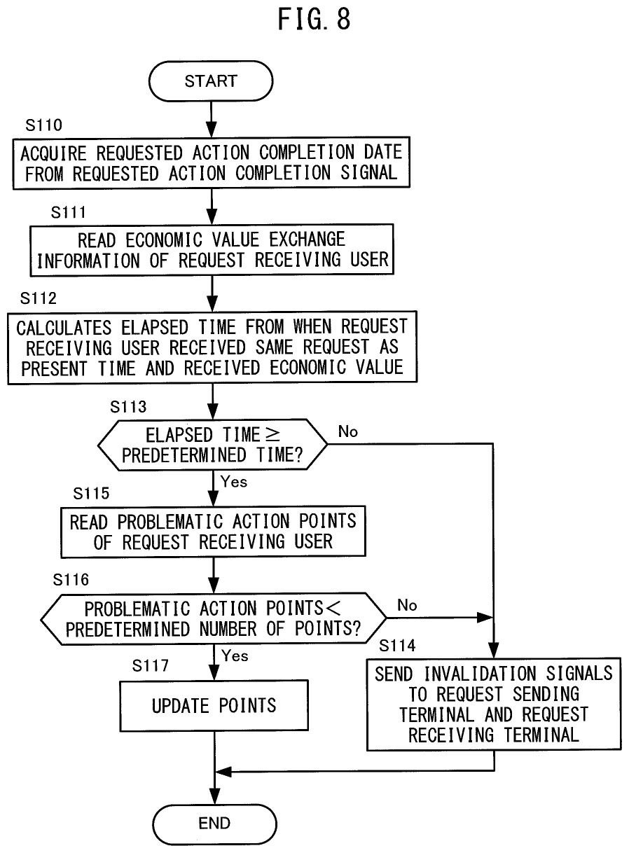

The processor 24 is one example of a control part and comprises one or more CPUs (central processing units) and their peripheral circuits. The processor 24 may further comprise other processing circuits such as logic processing units or numeric processing units. The processor 24 performs processing relating to the server 2 in the processing for managing economic value and processing for updating the problematic action points. The processing relating to the server 2 in the processing for managing economic value will be explained later with reference to FIG. 8. Further, the processing relating to the server 2 in the processing for updating the problematic action points will be explained later with reference to FIG. 7.

Next, referring to FIG. 3, details of the terminals 3-1 to 3-n will be explained. Note that, the terminals 3-1 to 3-n are configured the same in the constitutions relating to the processing for managing economic value and the processing for updating the problematic action points, so here, the configuration of the terminal 3-1 will be explained as representative of them.

FIG. 3 is a schematic view of the configuration of the terminal 3-1.

The terminal 3-1 comprises a user interface 31, wireless communication circuit 32, position measurement circuit 33, memory 34, and processor 35. The terminal 3-1 may further comprise a short distance wireless communication circuit (not shown) for wireless communication with car-mounted equipment.

The user interface 31, for example, is a touch panel display. The user interface 31 generates signals corresponding to the various types of operations by the user and outputs those signals to the processor 35. Further, the user interface 31 displays various types of information for display use received from the processor 35.

The wireless communication circuit 32, for example, comprises an antenna and a signal processing circuit performing various types of processing relating to wireless communication such as modulation and demodulation of the wireless signals. The wireless communication circuit 32 receives a wireless signal of a downlink from a wireless base station 6 or sends a wireless signal of an uplink to a wireless base station 6. That is, the wireless communication circuit 32 takes out from the wireless signal of a downlink received from a wireless base station 6 the signal sent from the server 2 to the terminal 3-1 and forwards it to the processor 35. Further, the wireless communication circuit 32 generates a wireless signal of an uplink including the signal received from the processor 35 and sent to the server 2 and sends this wireless signal.

The position measurement circuit 33 acquires information expressing the position of the terminal 3-1. The position measurement circuit 33, for example, comprises a receiver receiving a GPS signal and a processing circuit calculating the position of the terminal 3-1 from the GPS signal. The position measurement circuit 33 measures the position of the terminal 3-1 based on the GPS signal and notifies that position to the processor 35 each time it measures the position of the terminal 3-1.

The memory 34, for example, comprises a rewritable nonvolatile semiconductor memory and a rewritable volatile semiconductor memory. The memory 34 stores various types of application programs run by the processor 35 and various types of data. Further, the memory 34 stores various types of data relating to the performance of processing for managing economic value.

The processor 35 comprises one or more CPUs and their peripheral circuits. The processor 35 may further comprise other processing circuits such as logic processing units and numeric processing units. The processor 35 performs processing relating to the terminal 3-1 in the processing for managing economic value and the processing for updating the problematic action points. For example, in accordance with need, the processor 35 generates a signal for transmission to the server 2 and outputs the generated signal to the wireless communication circuit 32.

FIG. 4 is a view showing an example of a state in the economic value management system 1 where processing for managing economic value and processing for updating problematic action information are performed.

In the example shown in FIG. 4, on a one-side two-lane road, a driver of a vehicle 4-1 (user of a terminal 3-1) tries to receive a request for passing (request for lane change) from another vehicle to obtain economic value by deliberately driving on the passing lane at a low speed, changing to the cruising lane each time the driver receives a request for passing, and changing lanes again to the passing lane after finishing being passed. That is, the driver of the vehicle 4-1 repeatedly changes lanes from the passing lane to a cruising lane and changes lanes from a cruising lane to the passing lane.

The driver of the vehicle 4-2 (the user of the terminal 3-2) makes a request for passing to the driver of the vehicle 4-1 (the user of the terminal 3-1) driving in this way and finishes passing the vehicle 4-1 changed in lane to the cruising lane after the request is agreed to.

The driver of the vehicle 4-3 (the user of the terminal 3-3) reports the vehicle 4-1 driving in this way as a “problem vehicle”.

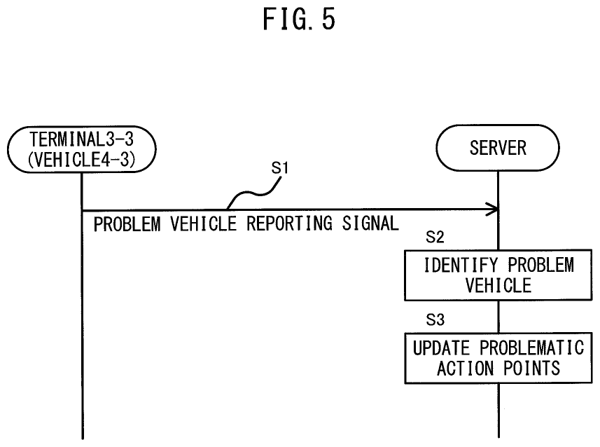

FIG. 5 is a view showing one example of a sequence of operations in processing for updating problematic action points and a view showing the flow of processing for updating problematic action points in the case where in the state shown in FIG. 4, the driver of the vehicle 4-3 (the user of the terminal 3-3) unrelated to the exchange of economic value between the driver of the vehicle 4-1 (the user of the terminal 3-1) and the driver of the vehicle 4-2 (the user of the terminal 3-2) reports the vehicle 4-1 as a problem vehicle. Note that, in this sequence of operations, the processing by the server 2 is performed by the processor 24 of the server 2.

At step S1, the terminal 3-3 sends a problem vehicle report signal including the license plate number of the problem vehicle and the date and time of report to the server 2.

In the present embodiment, when the user inputs the license plate number of the problem vehicle through a problem vehicle report application running on the terminal 3-3, the terminal 3-3 sends a problem vehicle report signal including the input license plate number and the date and time of input of the license plate number corresponding to the date and time of report to the server 2. Further, in addition to such a method as well, for example, if the vehicle 4-3 mounts cameras able to capture images ahead of, behind, and at the sides of the vehicle 4-3, it is also possible to read from the images captured by the cameras the license plate number of the problem vehicle and send a problem vehicle report signal including that read license plate number and the date and time of capture corresponding to the date and time of report to the server 2 when the user of the terminal 3-3 indicates his intent of reporting a problem vehicle.

At step S2, the server 2 refers to the identification information of the terminals 3-1 to 3-n and the identification information of the vehicles 4-1 to 4-n stored in the storage device 22 and identifies the vehicle reported as a problem vehicle and the terminal associated with the vehicle reported as a problem vehicle based on the license plate number of the problem vehicle included in the problem vehicle report signal.

At step S3, the server 2 reads the current problematic action points of the user of the identified terminal from the storage device 22 and adds one point to the read problematic action points to update the problematic action points.

That is, in the present embodiment, the server 2 counts the number of times being reported as a problem vehicle as the “problematic action points” and adds one point at a time to the problematic action points each time the vehicle is reported as a problem vehicle. Note that, in addition to such a method, for example it is also possible to include details of the problematic action in the problem vehicle report signal and change the number of points added in accordance with the details of the problematic action.

Note that, the server 2 periodically updates the problematic action points of the users of the terminals 3-1 to 3-n stored in the storage device 22 (for example, every day) so as to make the problematic action points the cumulative points for a certain time frame in the past (for example one year) and subtracts the number of points after the elapse of a certain time frame from when being added from the problematic action points.

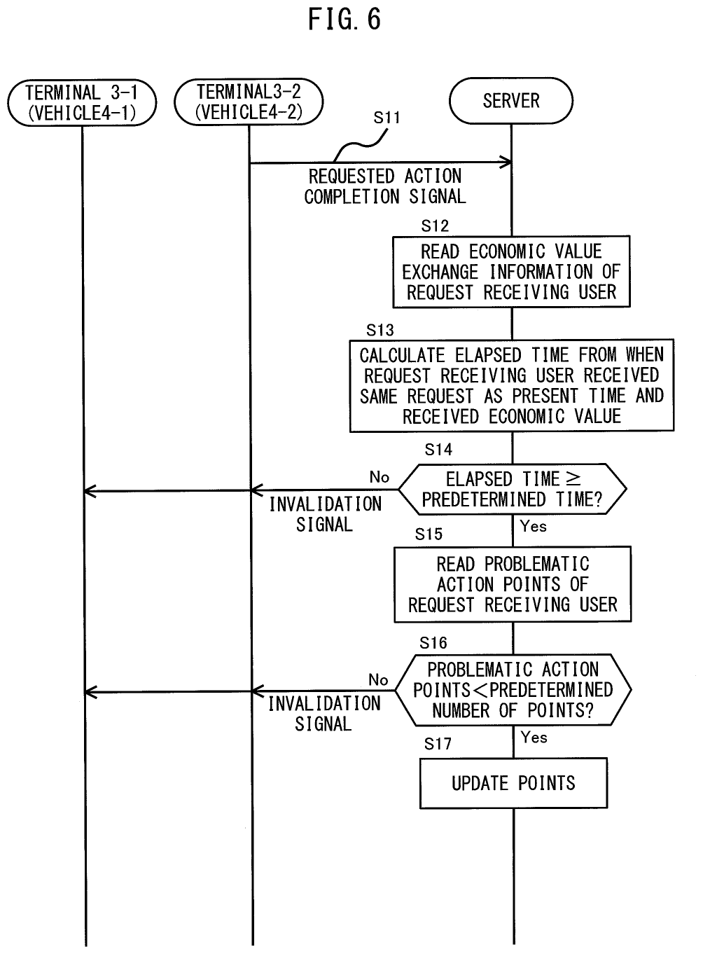

FIG. 6 is a view showing one example of a sequence of operations in processing for managing economic value and a view showing the flow of processing for managing economic value when, in the state shown in FIG. 4, the driver of the vehicle 4-2 (the user of the terminal 3-2) requests the driver of the vehicle 4-1 (the user of the terminal 3-1) to change lanes from the passing lane to the cruising lane so that he may pass the vehicle 4-1 and finishes passing it after the request is agreed to. In this sequence of operations as well, the processing by the server 2 is performed by the processor 24 of the server 2.

Note that, in the following explanation, for convenience, in accordance with need, a terminal of a user requesting specific action (in this example, a request for passing (request for lane change from the passing lane to a cruising lane)) be taken will be referred to as a “request sending terminal” and the vehicle associated with that request sending terminal will be referred to as a “request sending vehicle”. Further, a terminal of a user requested to take a specific action will be referred to as a “request receiving terminal” and the vehicle associated with the request receiving terminal will be referred to as a “request receiving vehicle”. Therefore, in the state shown in FIG. 4, the terminal 3-2 becomes the request sending terminal while the terminal 3-1 becomes the request receiving terminal. Further, the vehicle 4-2 becomes the request sending vehicle while the vehicle 4-1 becomes the request receiving vehicle.

At step S11, if the request sending terminal 3-2 finishes passing the vehicle it requests to pass (request for lane change), that is, the request receiving vehicle 4-1, it sends to the server 2 a requested action completion signal including the effect of notification of intent to pay economic value due to the completion of the requested action and the date and time of requested action completion when the requested action was completed.

When, for example, the user of the request sending terminal 3-2 inputs the fact of completion of the action requested to the user of the request receiving terminal 3-1 (in this example, passing) to the request sending terminal 3-2, the request sending terminal 3-2 sends a requested action completion signal to the server 2. Further, in addition to such a method, for example, if the vehicle 4-2 mounts cameras able to capture images ahead of, behind, and at the sides of the request sending vehicle 4-2, it is also possible to automatically judge the completion of the requested action (in this example, passing) based on the images captured by the cameras and send a requested action completion signal to the server 2.

At step S12, the server 2 reads the economic value exchange information of the user of the request receiving terminal 3-1 (request receiving user) receiving the request for passing from the request sending terminal 3-2 from the economic value exchange information of the users of the terminals 3-1 to 3-n stored in the storage device 22. The economic value exchange information, as explained before, includes content of a request when a request for passing, request for movement from a parking space, or other request for the users of the terminals 3-1 to 3-n to take specific action accompanied with exchange of economic value are made, and the date and time of economic value receipt when that request is agreed to and economic value is received.

At step S13, the server 2 first acquires the date and time of economic value receipt when the user of the request receiving terminal 3-1 previously received the same request as the currently received request (in this example, a request for passing) and received economic value based on the read economic value exchange information of the user of the request receiving terminal 3-1. That is, the server 2 acquires the closest date and time when the user of the request receiving terminal 3-1 received the same request as the current one and received economic value. Further, the server 2 calculates the elapsed time from the date and time of economic value receipt acquired at step S12 to the date and time of requested action completion. That is, the server 2 calculates the elapsed time from the closest date and time when the user of the request receiving terminal 3-1 received a request the same as the present time and received economic value.

At step S14, the server 2 judges if the elapsed time calculated at step S13 is a predetermined time or more. Further, if the elapsed time is less than the predetermined time, the server 2 judges that the user of the request receiving terminal 3-1 deliberately is repeating action for obtaining a request for passing (that is, request for specific action) in a short time frame, sends invalidation signals including a notification to the effect of invalidating the exchange of economic value to the request sending terminal 3-2 and the request receiving terminal 3-1, and ends the processing for managing economic value. On the other hand, if the elapsed time is the predetermined time or more, the server 2 proceeds to the processing of step S15.

Note that, in the present embodiment, the exchange of economic value is invalidated when in this way the elapsed time is less than the predetermined time, but the disclosure is not limited to this. For example, it is also possible to lower the amount of payment of economic value from the request sending terminal 3-2 to the request receiving terminal 3-1 from the usual amount.

At step S15, the server 2 reads the problematic action points of the user of the request receiving terminal 3-1 from among the problematic action points of the users of the terminals 3-1 to 3-n stored in the storage device 22.

At step S16, the server 2 judges if the problematic action points of the user of the request receiving terminal 3-1 are less than a predetermined number of points. Further, if the problematic action points are the predetermined number of points or more, the server 2 judges that the user of the request receiving terminal 3-1 is repeatedly taking a problematic action to deliberately induce another user to make a request so that it can obtain economic value, sends invalidation signals including notifications to the effect of invalidating the exchange of economic value to the request sending terminal 3-2 and the request receiving terminal 3-1, and ends the processing for managing economic value. On the other hand, if the problematic action points are less than the predetermined number of points, the server 2 proceeds to the processing of step S17.

Note that, in the present embodiment as well, the exchange of economic value is invalidated when in this way the problematic action points are the predetermined number of points or more, but the disclosure is not limited to this. It is also possible to lower the amount of payment of economic value from the request sending terminal 3-2 to the request receiving terminal 3-1 from the usual amount.

At step S17, the server 2 updates the points (economic value) held by the user of the request sending terminal 3-2 and the user of the request receiving terminal 3-1. Specifically, the server 2 subtracts from the points held by the user of the request sending terminal 3-2 the points corresponding to the total of the amount of payment for getting a specific action (in this example, lane change) performed and a handling fee. Further, the server 2 adds to the points held by the user of the request receiving terminal 3-1 the amount of payment for performing the specific action. At this time, the server 2 may also notify the points after subtraction to the request sending terminal 3-2. Further, the server 2 may also notify the points after addition to the request receiving terminal 3-1.

FIG. 7 is a flow chart for explaining processing relating to the server 2 in processing for updating problematic action points. The processor 24 performs processing relating to the server 2 in the processing for updating the problematic action points in accordance with the present routine when the server 2 receives a problem vehicle report signal.

At step S101, based on the identification information of the terminals 3-1 to 3-n and the identification information of the vehicles 4-1 to 4-n stored in the storage device 22 and the license plate number of the problem vehicle contained in the problem vehicle report signal, the processor 24 identifies the vehicle reported as a problem vehicle and the terminal associated with the vehicle reported as a problem vehicle.

At step S102, the processor 24 reads the current problematic action points of the user of the terminal identified at step S101 from the storage device 22 and adds one point to the read problematic action points to update the problematic action points.

FIG. 8 is a flow chart for explaining processing relating to the server 2 in processing for managing economic value. The processor 24 of the server 2 performs processing relating to the server 2 in the processing for managing economic value in accordance with the present routine when the server 2 receives a requested action completion signal.

At step S110, the processor 24 extracts from the requested action completion signal the date and time of completion of the requested action.

At step S111, the processor 24 reads from the economic value exchange information of the users of the terminals 3-1 to 3-n stored in the storage device 22 the economic value exchange information of the user of the request receiving terminal requested by the user of the request sending terminal to take a specific action accompanied with exchange of economic value.

At step S112, the processor 24 extracts from the economic value exchange information of the user of the request receiving terminal the content of the request when the user of the request receiving terminal was requested to take specific action accompanied with exchange of economic value in the past and the date and time of economic value receipt when it agreed to the request and received the economic value. Further, it acquires the date and time of economic value receipt when the user of the request receiving terminal previously received the same request as the currently received request and received economic value. That is, the server 2 acquires the closest date and time when the user of the request receiving terminal received the same request as the current one and received economic value.

Further, the processor 24 calculates the elapsed time from the date and time of economic value receipt to the date and time of requested action completion. That is, the server 2 calculates the elapsed time from the closest date and time when the user of the request receiving terminal 3-1 received the same request as the current one and received economic value.

At step S113, the processor 24 judges if the elapsed time calculated at step S112 is a predetermined time or more. If the elapsed time is less than the predetermined time, the processor 24 judges that the user of the request receiving terminal is repeatedly taking action for receiving a request for taking specific action from another in a short time frame with the aim of obtaining economic value and proceeds to the processing of step S114. On the other hand, if the elapsed time is the predetermined time or more, the processor 24 proceeds to the processing of step S115.

At step S114, the processor 24 sends an invalidation signal including notification to the effect of invalidating exchange of economic value to the request sending terminal 3-2 and the request receiving terminal 3-1.

At step S115, the processor 24 reads the problematic action points of the user of the request receiving terminal from among the problematic action points of the users of the terminals 3-1 to 3-n stored in the storage device 22.

At step S116, the processor 24 judges if the problematic action points of the user of the request receiving terminal are less than predetermined points. If the problematic action points of the user of the request receiving terminal is the predetermined points or more, the processor 24 judges that the user of the request receiving terminal is repeating problematic action to thereby deliberately induce a request from another user for its obtaining economic value and proceeds to the processing of step S114. On the other hand, if the problematic action points is less than the predetermined points, the processor 24 proceeds to the processing of step S117.

At step S117, the processor 24 reads the points of the user of the request sending terminal and the user corresponding to the request receiving terminal from the storage device 22 and updates the read points.

Specifically, the processor 24 subtracts from the points of the user of the request sending terminal the points corresponding to the total of the amount of payment for getting the specific action taken and the handling fee to update the points of the user of the request sending terminal and stores the updated points in the storage device 22. Further, the processor 24 adds to the points of the user of the request receiving terminal the amount of payment for having taken specific action to update the points of the user of the request receiving terminal and stores the updated points in the storage device 22.

The server 2 (economic value management apparatus) according to the present embodiment explained above comprises a communication interface 21 (communication part) able to communicate with the plurality of terminals 3-1 to 3-n associated with different vehicles 4-1 to 4-n, a storage device 22 (storage part) storing economic value held by the users of the plurality of terminals 3-1 to 3-n or the vehicles 4-1 to 4-n associated with the plurality of terminals 3-1 to 3-n, and a processor 24 (control part).

Further, the processor 24 is configured to assess the action relating to operation of a request receiving vehicle associated with a request receiving terminal when receiving a requested action completion signal from one terminal among the plurality of terminals 3-1 to 3-n becoming the request sending terminal to the effect of paying another terminal among the plurality of terminals 3-1 to 3-n becoming the request receiving terminal economic value as payment for having taken an action requested from the request sending terminal and, when the assessment of the action relating to operation of the request receiving vehicle is less than a predetermined assessment, invalidate the payment of economic value to the request receiving terminal or lower the amount of payment of economic value compared with when it is the predetermined assessment or more.

Due to this, it is possible to keep a person low in assessment of action relating to driving from being given economic value, so it is possible to keep a person taking problematic action contrary to traffic rules or morals from ending up being given economic value. Further, as a result, it is possible to keep problematic action itself from being performed to obtain economic value.

Further, the processor 24 (control part) of the server 2 according to the present embodiment more particularly is configured to use as an indicator of the assessment of the action relating to operation of the request receiving vehicle the elapsed time from the closest date and time of making the economic value held by the user of the request receiving terminal or the request receiving vehicle increase due to taking the same action and, when the elapsed time is less than the predetermined time, judge that the assessment of the action relating to the operation of the request receiving vehicle is less than a predetermined assessment.

Due to this, it is possible to keep a person repeatedly taking action for obtaining economic value in a short time frame from ending up being given economic value.

Further, the processor 24 (control part) of the server 2 according to the present embodiment, more specifically, is configured to update problematic action points of a problem vehicle or a user of a terminal associated with the problem vehicle to an increasing side and store the updated problematic action points in the storage device 22 (storage part) when receiving problem vehicle report signals including information for identifying a problem vehicle from a plurality of terminals 3-1 to 3-n and to use as an indicator of assessment of taking action relating to operation of the request receiving vehicle the problematic action points of the user of the request receiving terminal or the request receiving vehicle and judge that the assessment of taking action relating to operation of the request receiving vehicle is less than a predetermined assessment when the problematic action points of the user of the request receiving terminal or the request receiving vehicle is a predetermined points or more.

Due to this, it is possible to judge whether a problematic action is taken based on objective judgment criteria. Further, it is possible to keep a person repeatedly taking problematic action to thereby deliberately induce a request at another user for its obtaining economic value from ending up being given economic value.

Further, the economic value management method performed at the server 2 (economic value management apparatus) according to the present embodiment able to communicate with the above explained plurality of terminals 3-1 to 3-n is an economic value management method managing economic value, stored in the server 2, which users of a plurality of terminals 3-1 to 3-n or vehicle 4-1 to 4-n associated with the plurality of terminals 3-1 to 3-n hold, more particularly is one which, when one terminal among the plurality of terminals 3-1 to 3-n becoming the request sending terminal pays another terminal among the plurality of terminals 3-1 to 3-n becoming the request receiving terminal economic value as payment for having taken an action requested from the request sending terminal, assesses the action relating to operation of the request receiving vehicle associated with the request receiving terminal and, when the assessment of the action relating to operation of the request receiving vehicle is less than a predetermined assessment, invalidates the payment of economic value to the request receiving terminal or lowers the amount of payment of economic value compared with the case where it is the predetermined assessment or more.

According to this economic value management method, it is possible to keep a person low in assessment of taking action relating to driving from being given economic value, so it is possible to keep a person engaging in problematic action contrary to traffic rules or morals from ending up being given economic value. Further, as a result, it is possible to keep problematic action itself from being performed to obtain economic value.

### Second Embodiment

Next, an economic value management system 1 according to a second embodiment of the present disclosure will be explained. The economic value management system 1 according to the present embodiment differs from the first embodiment on the point of being designed to compare the driving state of a request receiving vehicle requested to take a specific action with the driving states of the vehicles around the request receiving vehicle so as to further judge if the request receiving vehicle is deliberately inducing a request for obtaining economic value. Below, this point of difference will be focused on in the explanation.

The economic value management system 1 according to the present embodiment is basically similar in configuration to the first embodiment, but the terminals 3-1 to 3-n are configured so that when the ignition switches of the vehicles 4-1 to 4-n associated with the terminals 3-1 to 3-n are turned to ON, they send the current positions and speeds of the vehicles 4-1 to 4-n associated with the terminals 3-1 to 3-n to the server 2 every predetermined time.

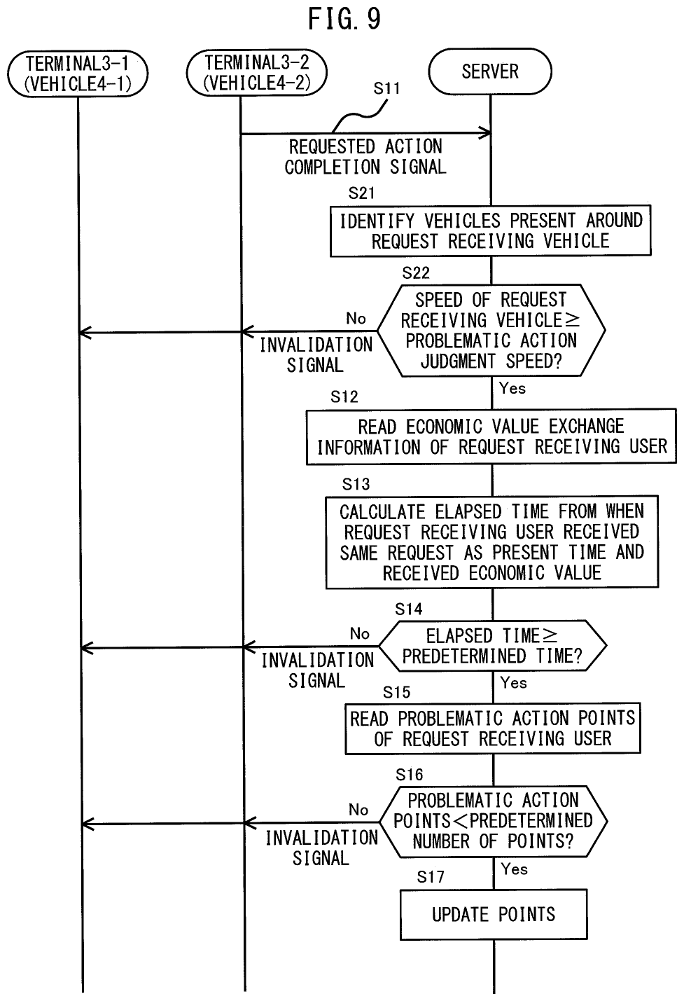

FIG. 9 is view showing one example of the sequence of operations in processing for managing economic value according to the present embodiment. In the same way as the first embodiment, this is a view showing the flow of processing for managing economic value when in the state shown in FIG. 4, the driver of the vehicle 4-2 (the user of the terminal 3-2) requests to the driver of the vehicle 4-1 (the user of the terminal 3-1) a lane change from the passing lane to a cruising lane so as to overtake the vehicle 4-1 and the request is met and the vehicle finishes being overtaken. Note that, in FIG. 9, step S11 to step S17 perform processing similar to the first embodiment, so here the explanations will be omitted.

At step S21, the server 2 identifies vehicles present around the request receiving vehicle 4-1 (for example, within a range of several hundred meters to several kilometers) based on the current position of the request receiving vehicle 4-1 periodically sent from the request receiving terminal 3-1 to the server 2 and stored in the storage device 22 and the current positions of the vehicles 4-1 to 4-n stored in the storage device 22.

At step S22, the server 2 judges if the speed of the request receiving vehicle 4-1 periodically sent from the request receiving terminal 3-1 to the server 2 and stored in the storage device 22 is a speed corresponding to a predetermined percent of a mean value of speeds of surrounding vehicles identified at step S21 (a value of less than 100%, for example, 80%) (below, referred to as a “problematic action judgment speed”) or more.

If the speed of the request receiving vehicle 4-1 is less than the problematic action judgment speed, that is, if there is a certain discrepancy or more between the driving state of the request receiving vehicle and the driving states of vehicles around the request receiving vehicle, the server 2 judges that the request receiving vehicle 4-1 is being driven so as to deliberately induce a request for obtaining economic value, sends invalidation signals including notifications to the effect of invalidating the exchange of economic value to the request sending terminal 3-2 and the request receiving terminal 3-1, and ends the processing for managing economic value.

On the other hand, the server 2 proceeds to the processing of step S12 if the speed of the request receiving vehicle 4-1 is the problematic action judgment speed or more.

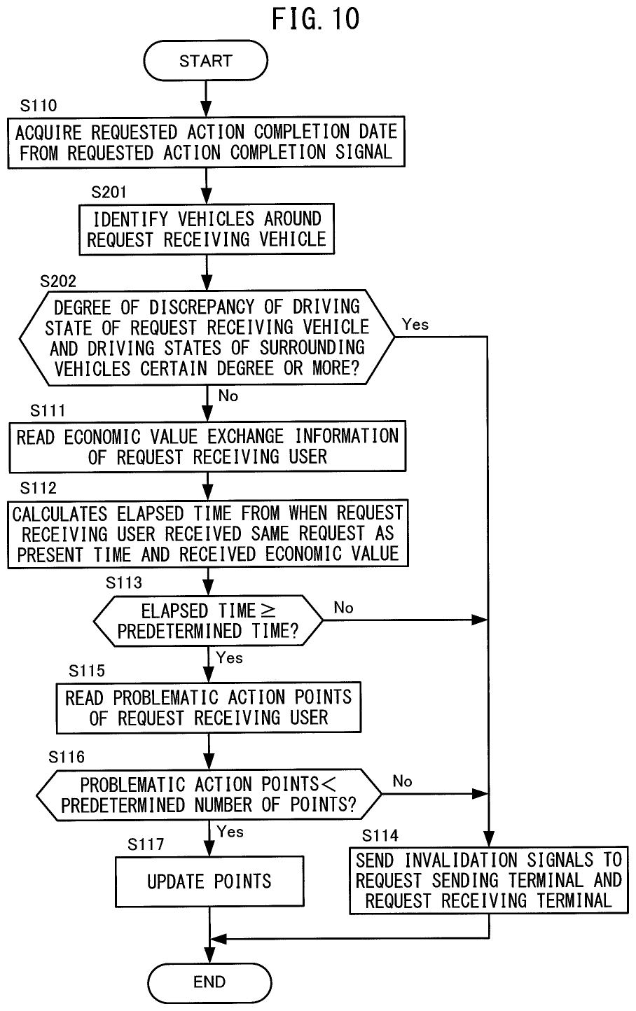

FIG. 10 is a flow chart for explaining processing relating to the server in processing for managing economic value according to the present embodiment. The processor 24 performs processing relating to the server 2 in the processing for managing economic value in accordance with the present routine when the server 2 receives a signal of completion of a requested action. Note that, in FIG. 10, step S110 to step S117 perform processing similar to the first embodiment, so here explanations will be omitted.

At step S201, the processor 24 identifies the vehicles present around the request receiving vehicle based on the current position of the request receiving vehicle periodically sent from the request receiving terminal to the server 2 and stored in the storage device 22 and the current positions of the vehicles 4-1 to 4-n stored in the storage device 22.

At this time, the processor 24 identifies vehicles in a driving state among the vehicles present around the request receiving vehicle if the request from the request sending terminal is for example a request for passing. Further, the processor 24 identifies vehicles in a parked state among the vehicles present around the request receiving vehicle if the request from the request sending terminal is for example a request for movement from a parking space.

At step S202, the processor 24 judges if the degree of discrepancy between the driving state of the request receiving vehicle and the driving states of the vehicles around the request receiving vehicle is a predetermined value or more. The processor 24 proceeds to the processing of step S114 if the degree of discrepancy between the driving state of the request receiving vehicle and the driving states of the vehicles around the request receiving vehicle is a predetermined value or more and proceeds to the processing of step S11 if it is less than the predetermined value.

If the request from the request sending terminal was for example a request for passing, the processor 24 judges that the degree of discrepancy between the driving state of the request receiving vehicle and the driving states of the vehicles around the request receiving vehicle is a predetermined value or more if the speed of the request receiving vehicle periodically sent from the request receiving terminal to the server 2 and stored in the storage device 22 is less than a problematic action judgment speed corresponding to a predetermined percent of a mean value of speeds of surrounding vehicles identified at step S201 (a value of less than 100%, for example, 80%).

Further, if the request from the request sending terminal was for example a request for movement from a parking space, the processor 24 judges that the degree of discrepancy between the driving state of the request receiving vehicle and the driving states of the vehicles around the request receiving vehicle is a predetermined value or more if the time during which a request receiving vehicle does not move from its current position and remains at a parking space from when the ignition switch of the request receiving vehicle is turned to ON and the current position of the request receiving vehicle (parked position) is sent to the server 2 is a problematic action judging time, or more, corresponding to a predetermined percent (a value larger than 100%, for example, 120%) of a mean value of times during which parked vehicles remain at parking spaces from when ignition switches of the parked vehicles present around the request receiving vehicle are turned to ON.

The server 2 (economic value management apparatus) according to the embodiment explained above comprises parts similar to the first embodiment such as a communication interface 21 (communication part), storage device 22 (storage part), and processor 24 (control part).

Further, the processor 24 is further configured so as to use as an indicator of the assessment of the action relating to operation of the request receiving vehicle the degree of discrepancy between the driving state of the request receiving vehicle and the driving states of the vehicles around the request receiving vehicle and to judge that the assessment of the action relating to operation of the request receiving vehicle is less than a predetermined assessment when the degree of discrepancy is a predetermined degree of discrepancy or more.

Due to this, effects similar to the first embodiment are obtained. In addition, it is possible to judge whether a request for enabling the request receiving vehicle to obtain economic value is being deliberately induced by comparing with the driving states of the vehicles around the request receiving vehicle.

Above, embodiments of the present disclosure were explained, but the above embodiments only show some of the examples of application of the present disclosure. It is not meant to limit the technical scope of the present disclosure to the specific constitutions of the embodiments.

1. An economic value management apparatus comprising:
a communication part configured to be able to communicate with a plurality of terminals associated with different vehicles;
a storage part configured to store economic value held by users of the plurality of terminals or the vehicles associated with the plurality of terminals; and
a control part, wherein
the control part is configured so that:
when receiving from one terminal among the plurality of terminals becoming a request sending terminal a signal to the effect of paying another terminal among the plurality of terminals becoming a request receiving terminal the economic value as payment for having taken an action requested from the request sending terminal, it assesses the action relating to the operation of the request receiving vehicle associated with the request receiving terminal; and,
when the assessment of the action relating to operation of the request receiving vehicle is less than a predetermined assessment, it invalidates the payment of economic value to the request receiving terminal or lowers the amount of payment of economic value compared with the case where the assessment is the predetermined assessment or more.

2. The economic value management apparatus according to claim 1, wherein
the control part is configured so as to:
use as an indicator of assessment of an action relating to operation of the request receiving vehicle an elapsed time from the closest date and time when making the economic value held by the user of the request receiving terminal or the request receiving vehicle increase due to the same action being taken; and
judge that the assessment of action relating to operation of the request receiving vehicle is less than a predetermined assessment when the elapsed time is less than a predetermined time.

3. The economic value management apparatus according to claim 1, wherein
the control part is configured so as to:
update to the increased side the problematic action points of the problem vehicle or the user of the terminal associated with the problem vehicle when receiving a signal including information for identifying a problem vehicle from the plurality of terminals and store the updated problematic action points to the storage part;
use as an indicator of the assessment of the action relating to operation of the request receiving vehicle the problematic action points of the user of the request receiving terminal or the request receiving vehicle; and
judge that the assessment of the action relating to operation of the request receiving vehicle is less than a predetermined assessment when the problematic action points of the user of the request receiving terminal or the request receiving vehicle is a predetermined number of points or more.

4. The economic value management apparatus according to claim 1, wherein
the control part is configured so as to:
use as an indicator of the assessment of the action relating to operation of the request receiving vehicle the degree of discrepancy between the driving state of the request receiving vehicle and the driving states of the vehicles around the request receiving vehicle; and
judge that the assessment of the action relating to operation of the request receiving vehicle is less than a predetermined assessment when the degree of discrepancy is a predetermined degree of discrepancy or more.

5. An economic value management method for managing economic value which is stored in a server configured to be able to communicate with a plurality of terminals and is held by users of the plurality of terminals or vehicles associated with the plurality of terminals, wherein
the economic value management method:
assesses the action relating to the operation of the request receiving vehicle associated with the request receiving terminal when one terminal among the plurality of terminals becoming a request sending terminal pays economic value to another terminal among the plurality of terminals becoming a request receiving terminal as payment for having taken an action requested from a request sending terminal; and
invalidates the payment of economic value to the request receiving terminal or lowers the amount of payment of economic value compared with the case where the assessment is the predetermined assessment or more when the assessment of the action relating to operation of the request receiving vehicle is less than a predetermined assessment.
